(19) United States
(12) Patent Application Publication
(10) Pub. No.: US 2026/0187787 A1
(43) Pub. Date: Jul. 2, 2026

(54) SYSTEM AND METHOD FOR THE OPTICAL INSPECTION OF OBJECTS

(71) Applicant: WAHTARI GMBH, Haar (DE)

(72) Inventors: Roland SINGER, Baldham (DE); Sebastian BORCHERS, Kirchseeon (DE); Marwin GAMBEL, München (DE)

(21) Appl. No.: 19/128,128

(22) PCT Filed: Nov. 7, 2023
(86) PCT No.: PCT/EP2023/080945

§ 371 Date: Sep. 15, 2025

(30) Foreign Application Priority Data
Nov. 7, 2022 (DE) 10 2022 129 386.6

(51) Int. Cl. G06T 7/00; G01B 11/24; G01N 21/88; G01N 21/89

(52) U.S. Cl. CPC G06T 7/001; G01B 11/24; G01N 21/8914; G01N 2021/8893; G06T 2207/20081; G06T 2207/20084

(57) ABSTRACT

The present invention relates to a system (100) for the optical inspection of objects (102), comprising: one or more detection units (104) for, in particular, continuous optical detection of at least one object (102) to be inspected in a measuring range (106) and for providing image information of the detected object (102); and a computing unit (110) which is designed and programmed to inspect the detected object (102) using the image information provided based on one or more, in particular positive, reference objects and to provide a corresponding inspection result about the object (102) in question. The invention also relates to a method for the optical inspection of objects (102).

### CROSS REFERENCE TO RELATED APPLICATIONS

The present application is a U.S. National Phase of International Application No. PCT/EP2023/080945 entitled “SYSTEM AND METHOD FOR OPTICALLY INSPECTING OBJECTS”, and filed on Nov. 7, 2023. International Application No. PCT/EP2023/080945 claims priority to German Patent Application No. 10 2022 129 386.6 filed on Nov. 7, 2022. The entire contents of each of the above-listed applications are hereby incorporated by reference for all purposes.

### TECHNICAL FIELD

The present invention relates to a system and a method for the optical inspection of objects.

### BACKGROUND AND SUMMARY

Increasing demands on already high quality standards, such as those demanded by the automotive industry, pose increasing problems for the detection of defects in raw materials, intermediate products and/or products using conventional measuring and testing technology. Added to this are requirements such as 100% control and traceability of raw materials, intermediate products and/or products.

There is therefore a particular need to simultaneously analyze various parameters and quality characteristics in individual tests (e.g. test bench) and/or in ongoing production (e.g. inline). The highest speeds, maximum data security and lowest latencies are required here. Furthermore, standard solutions for (optical) quality assurance cannot always be adapted or applied to the usually individually configured industrial systems for processing and/or manufacturing raw materials, intermediate products and/or products, particularly with regard to lighting conditions and/or viewing angles.

The present invention is therefore based on the task of solving the aforementioned problems, in particular providing a system and a method for the optical inspection of objects, which in particular enables a reliable and efficient inspection of objects.

According to the invention, this task is solved by the system and method having the features as described herein.

The system according to the invention for the optical inspection of objects has: one or more detection units for, in particular, continuous optical detection of at least one object to be inspected in a measuring range and for providing image information of the detected object; and a computing unit which is designed and programmed to inspect the detected object using the image information provided based on one or more, in particular positive, reference objects and to provide a corresponding inspection result about the object in question.

The invention is based in particular on the idea that the computing unit inspects or can inspect objects purely on the basis of positive reference objects, for example (actual) good examples or (actual) good samples. In particular, at least one part of the arithmetic unit can be taught or can be taught purely on the basis of said positive reference objects or good examples. In particular, this part of the computing unit can be configured as an artificial neural network. In other words, this means that negative reference objects or bad examples are not required for an inspection. The system can therefore be operated efficiently or be operable. In particular, the efficiency of the system can be increased, since an inspection can only be carried out on the basis of said positive reference objects and, for example, a comparison with numerous negative reference objects is thus avoided. It should be understood that the positive reference objects are not generated artificially, but that the reference objects are or can only be generated in particular by taking images of original good objects. However, it should be understood that, additionally or alternatively, the positive reference objects can be recorded and can also be generated artificially, and that, additionally or alternatively, negative reference objects can optionally be provided, which can be generated artificially. This allows a flexibly configurable system to be provided. Furthermore, the system can be commissioned quickly, as it is possible to inspect objects with a positive reference object in particular. In other words, the system can be taught with a positive reference object for the time being, particularly with regard to object features to be inspected. Commissioning therefore requires (virtually) no specialist knowledge of the object to be inspected, as the object features can be taught or trained using the positive reference object in accordance with the “teach & go” principle described, particularly by means of the artificial neural network.

It may be provided that an object may be any starting material, intermediate product and/or product. In particular, an object may be a plate-shaped object, a cylindrical object, a tubular object (e.g. with a circular or an oval-shaped cross-section) and/or a longitudinally extending object. It is also conceivable that the object can be angled and/or curved. It is also conceivable that an object may have a symmetrical or an asymmetrical cross-section. It should also be understood that the object may also have a combination of the aforementioned exemplary embodiments. For example, a longitudinally extending object may comprise at least one of the following: Cables; fiberglass; wires; metal, wood and/or plastic profiles; tubes; ropes; yarns; chains; drills; threaded rods; screws; nails; and/or pins. Furthermore, it should be understood that a longitudinally extending object may also comprise several of the aforementioned elements, such as two or more interconnected, in particular twisted and/or twisted cables and/or wires. For example, a plate-shaped object may comprise a pastry, e.g. cookies. For example, a cylindrical object may comprise a wooden profile, e.g. tree trunks. It should be understood that the above enumerations are purely exemplary and that the object may additionally or alternatively be shaped.

It may be provided that the computing unit has a locator module which is designed and programmed to determine an outer contour of the detected object in the image information and, optionally, to delete information content in the image information which can be assigned to an area outside the outer contour of the detected object. The locator module can be configured as an artificial neural network that has already been pre-trained or taught. As the outer contour can be determined using the locator module, the amount of information that has to be processed by the computing unit can be reduced. This can increase the efficiency of the computing unit and thus of the system. In addition, since the information that is not required can be deleted, the computing unit can be operated more economically, particularly with regard to storage capacities. Furthermore, since the outer contour can be determined, the locator module can additionally or alternatively be used to optically eliminate movements, e.g. vibrations, of the detected object, which can also lead to an improvement in the performance of the system.

It may be provided that the computing unit has one or more detection modules which are designed and programmed to use the image information to analyze the detected object for conformity with and/or deviations from one or more, in particular positive, reference objects and to provide a corresponding measured value. The one or more recognition modules can each be configured as a combination of artificial neural networks and conventional algorithms. Since the detected object can be analyzed on the basis of positive reference objects by means of the one or more detection modules and therefore only a match and/or a deviation from these can be analyzed, the system can be operated efficiently or can be operable. In particular, the efficiency of the system can be increased, as an analysis can only be carried out on the basis of said positive reference objects and, for example, a comparison with numerous negative reference objects is thus avoided.

It may be provided that at least one recognition module is designed and programmed for symbol recognition analysis, in particular text recognition analysis. For example, the recognition module for symbol recognition analysis can be designed and programmed as an OCR module, in particular to be able to analyze imprints (e.g. markings, codes, lettering and/or serial numbers) on the objects in question. It is possible that the recognition module for symbol recognition analysis is pre-trained or taught accordingly.

Additionally or alternatively, it may be provided that at least one detection module is designed and programmed for geometric measurement analysis. By means of the recognition module for geometric measurement analysis, for example, a specific dimension (e.g. a diameter) can be calculated at defined points within the image information of the objects in question, in particular it can be calculated quantitatively.

Additionally or alternatively, it may be provided that at least one detection module is designed and programmed for color analysis. In other words, the detection module for color analysis can be configured to monitor the color of the objects in question. For example, a color deviation of the objects in question can be calculable by means of the detection module for color analysis.

Additionally or alternatively, it may be provided that at least one detection module is designed and programmed for surface analysis and/or for general defect detection. In other words, it may be provided that at least one detection module is designed and programmed for anomaly detection. For example, fractures, cracks, incisions, holes, dents, pimples, foreign particles and/or air bubbles in and/or on the objects can be determined by means of the detection module for surface analysis and/or for defect detection and/or for anomaly detection.

It may be provided that the computing unit has an evaluator module which is designed and programmed to determine whether the analyzed measured value is within predetermined limit values, whereby the corresponding inspection result can be generated via the object on the basis of this determination. The evaluator module can therefore classify the measured values and then provide the corresponding inspection result. It may be provided that the limit values in the computing unit can be flexibly changed by a user, in particular depending on an object to be inspected and/or a quality expectation for an object to be inspected. The limit values can represent a tolerance range of an acceptable quality deficit of the inspected objects with regard to the respective measured value category of the respective detection modules.

It may be provided that the inspection result can be made available, in particular to an output unit of the system for output to the user and/or to an interface for transmission to an additional system unit and/or unit assigned or assignable to the system. An output unit can be, for example, a display unit, e.g. a screen, and/or an alarm unit, e.g. an acoustic and/or visual alarm unit. The additional system unit and/or the unit assigned or assignable to the system may, for example, be configured as a big data unit and/or a cloud. Additionally or alternatively, the inspection result may be storable in a storage unit of the system. Additionally or alternatively, the interface can be configured as a programming interface (API) or an industrial interface (e.g. Profinet).

It may be provided that the computing unit has a trainer module which is designed and programmed to generate a first and/or at least one further, in particular positive, reference object, in particular for subsequent inspections, on the basis of the image information of the captured object if the captured object substantially corresponds to a target state. Additionally or alternatively, it may be provided that the trainer module is designed and programmed to artificially generate potential defect characteristics, preferably for subsequent inspections, in particular on the basis of the image information of the captured object. In particular, the trainer module can access the image information generated by the detection units in order to generate image information or image material for positive reference objects if the detected object essentially corresponds to a target state. The target state can be definable and/or determinable by a user in the computing unit. It may be provided that the target state has a tolerance range. In other words, the positive reference objects or their image information may comprise only or predominantly image information of positive reference objects, which consequently have no or only a few production errors/deviations within an acceptable tolerance range. If production errors/deviations are included, they must be clearly outnumbered, otherwise they are defined as acceptable production characteristics.

It may be provided that the computing unit has one or more teach-in modules corresponding to the one or more detection modules, which are designed and programmed to train the one or more detection modules on the basis of at least one, in particular positive, reference object. In other words, a teach-in module can be assigned to each recognition module. The one or more training modules can be configured as a combination of artificial neural networks and conventional algorithms. For example, it may be provided that at least one teach-in module is designed and programmed for symbol recognition analysis, in particular text recognition analysis. Additionally or alternatively, it may be provided that at least one teach-in module is designed and programmed for geometric measurement analysis. Additionally or alternatively, it may be provided that at least one teach-in module is designed and programmed for color analysis. Additionally or alternatively, it may be provided that at least one teach-in module is designed and programmed for surface analysis. By teaching or training the recognition modules using positive reference objects, the reliability and efficiency of the analyses of the recognition modules can be continuously increased as a function of a set of positive reference objects by means of which the recognition modules can be trained.

For example, it may be provided that one or more or each recognition module, in particular designed as a (e.g. deep) neural network, can be trained, in particular by means of a corresponding training module, for example, so that one or more probability values per image area and/or image pixel can be provided or output. In this case, it may be provided that provided values or output values can be set with regard to a defect probability, to color deviations, to shape deviations and/or to other desired or undesired optical features.

It may be provided that each detection unit has a trigger input by means of which an analogue trigger signal can be received, whereby each detection unit is configured to start and/or synchronize an optical detection, in particular with the computing unit, as soon as the analogue trigger signal is received. This can ensure that optical detection starts reliably, especially during an inline inspection, for example in a production plant. Furthermore, it can be provided that by means of the trigger input, for example by means of the trigger signal that can be received via it, an illumination assigned or assignable to the (e.g. each) detection unit can be started and/or synchronized. As a result, a corresponding power and/or cooling requirement can be reduced and/or optimized.

It may be provided that the measuring area, in which the at least one object to be inspected can be optically detected by means of the one or more detection units, is arranged in an at least partially or completely closed space, in particular a measuring chamber, of the system. Additionally or alternatively, it may be provided that the measuring area in which the at least one object to be inspected can be optically detected by means of the one or more detection units is arranged in an open space. Additionally or alternatively, it may be provided that the measuring area is arranged at or on a conveyor device, e.g. a conveyor belt. Additionally or alternatively, it may be provided that a conveyor device, e.g. an unwinding device and/or a winding device, is arranged upstream and/or downstream of the measuring area. For example, this may be the case with longitudinally extending objects and/or endless objects, such as a cable or extrusion objects. In other words, an object to be inspected can be conveyed by means of unwinding and winding through the measuring area and optionally through a production system in which the conveyor device can be arranged. It should be understood that the one or more detection units may be suitably arranged or locatable with respect to the measurement area for optically detecting objects in the measurement area.

For example, the system may have a measuring chamber comprising an input opening for receiving the object to be inspected into the measuring chamber and an output opening for discharging the inspected object out of the measuring chamber, said measuring area being arranged between the input opening and the output opening in the measuring chamber.

It may be provided that the one or more detection units are configured for, in particular, continuous optical detection of the object in the measuring range of the measuring chamber.

It may be provided that one or more or each detection unit is configured to illuminate the object coaxially during, in particular, continuous optical detection of the object (e.g. in the measuring chamber). This can provide a bright field that can ensure uniform illumination and avoid reflections. This lighting technique can be particularly suitable for reflective surfaces of all kinds, such as metals, glass, smooth or polished surfaces, etc. Thanks to a homogeneous light atmosphere, coaxial lighting can be particularly suitable for defect inspection on uneven surfaces. For example, details can be made visible despite creasing and/or curvature. The reliability of the system can thus be improved. It should be understood that alternative methods of illumination may also be conceivable, such as direct illumination, e.g. by means of a directional lighting device.

It may be provided that one or more or each detection unit comprises a camera for optically detecting the object and a light source for illuminating the object.

It may be provided that each camera is equipped with a lens. In general, any type of lens may be provided. For example, the lens may be a telecentric lens and/or a conventional, for example optically corrected, for example classically rectified lens, in particular with at least one adjustable lens.

One challenge here can be the shallower depth of field of a conventional lens compared to a telecentric lens. Since an object to be captured and/or inspected can move at least a little, e.g. vibrate at least a little, the image can become blurred if the object to be captured and/or inspected leaves the focus area or comes to the edge of the focus area.

It is conceivable to motorize the classic, rectified lens with one or more adjustable lenses via a stepper motor in such a way that the focus can be adjusted automatically (especially electronically). This method can be applied to zoom and/or aperture. Software (e.g. an AI-supported algorithm) can ensure that the focus is always optimal and the image remains sharp. The software can use a limit switch to determine which lens settings have been used. These can also be called up again later if, for example, the object to be captured and/or inspected is changed and the size and/or dimension and/or diameter of the object to be captured and/or inspected or its position changes.

The aperture can be set so that it is closed as wide as possible (small f-number). This allows the depth of field to be increased. At the same time, it can be ensured that the aperture setting does not block out too much light.

The advantages of such a classic, rectified lens over a telecentric lens include lower costs, less loss of light output (telecentric lenses have many lenses and mirrors that cost light output), as well as the possibility of further measurement (in particular size and/or dimension and/or diameter of the object to be captured and/or inspected), in particular via software calculation.

The distance between the object to be detected and/or inspected and the lens can be calculated from the zoom and/or focus positions of the lens, allowing the size and/or dimension and/or diameter of the object to be calculated. The lens settings (zoom and/or focus positions) can initially be calibrated via the built-in limit switch. This calculation can be performed independently with all available cameras to increase accuracy.

It may be provided that one or more or each detection unit comprises a camera for optically detecting the object, a light source for illuminating the object and a beam splitter for deflecting emitted light from the light source, wherein the camera, the light source and the beam splitter are arranged relative to each other in such a way that a central optical axis of the camera and light beams which can be emitted by the light source run parallel and/or coaxially to each other, wherein in particular the camera and the light source are arranged substantially at right angles to each other and the beam splitter is arranged at an angle of substantially 45° to each other, which can be emitted by the light source run parallel and/or coaxially to one another, in particular the camera and the light source being arranged essentially at right angles to one another and the beam splitter being arranged at an angle of essentially 45° to the central optical axis of the camera and a light-emitting direction of the light source. The design with a beam splitter, in particular a semi-transparent mirror, makes it possible for the camera to look directly at the object through the mirror glass of the beam splitter, which is transparent from one side, and not “through” the light source, as is the case with direct illumination (e.g. with a ring light). This can prevent the camera from being “dazzled” and image information about the captured object cannot be read out due to overexposure. As a result, the system can be operated more reliably and efficiently.

It may be provided that one or more or each detection unit has a diffuser, which can be arranged between the light source and the beam splitter. This can provide a highly diffuse bright field, which can ensure even more uniform illumination and avoid reflections even better.

It may be provided that each light source comprises at least one circuit board and a plurality of LEDs, which are arranged in a regular two-dimensional pattern on the circuit board. This makes it possible to achieve uniform and reliable illumination.

It may be provided that each light source has a power range of essentially 20 to 60 watts or 70 watts, preferably essentially 24 to 48 watts.

Alternatively, it is conceivable that each light source has a power range of essentially 100-150 watts. The exposure time of the camera sensors can then be reduced in order to avoid distortions in the image, particularly in order to be able to image moving objects at higher speeds.

It may also be provided that one or more, e.g. each, light source(s) can be operated in pulsed mode. This can provide powerful illumination for detecting even the smallest defects, which can also enable very fast image capturing or very short exposure times by the camera. Furthermore, in the case of a measuring chamber, the housing cannot be completely closed due to the short exposure times of the cameras. In other words, the entrance opening and the exit opening of the measuring chamber do not have to be completely light-tight. Due to the high luminosity of the installed light source, it may be possible to compensate for residual ambient light.

It may be provided that each light source has a color rendering index range of essentially 92 to 98, preferably essentially 94 to 96, in particular essentially 95. This can enable reliable color analysis.

For example, it may be provided that the system comprises several, e.g. three, detection units, the detection units being arranged at regular intervals from one another and in particular radially around the measuring range. Additionally or alternatively, it may be provided that several detection units are arranged at regular intervals from one another and in particular longitudinally along the measuring range. For example, the system can comprise six detection units, whereby three detection units forming a group are arranged radially around the measuring range and the respective groups are arranged longitudinally along the measuring range. In a sense, this can be seen as a 2×3 radial arrangement. This allows, for example, longitudinally extending objects, e.g. extrusion products or cables, to be optically detected completely and reliably.

It is also conceivable that the system comprises one detection unit or two detection units. This may be the case, for example, if no complete analysis/inspection is required and/or if a geometry and/or other property of an object to be inspected requires only one detection unit or two detection units for complete analysis/inspection.

In particular, it is conceivable that the system comprises a detection unit, preferably for inspecting one-dimensional features, in particular imprints or a print result, of an object to be inspected.

Additionally or alternatively, it may be conceivable that the system comprises a detection unit, preferably for inspecting partially or fully transparent objects to be inspected. Particularly in the case of completely transparent objects to be inspected, one detection unit may be sufficient for complete analysis/inspection.

In particular, it is conceivable that the system comprises two detection units, preferably for objects to be inspected with a suitable geometry such as flat profiles. The detection units can, for example, be oriented 180° and/or opposite each other or 90° and/or essentially perpendicular to each other. For example, one detection unit can detect a side view of the object to be inspected and/or one, for example the other, detection unit can detect a top or bottom view of the object to be inspected.

In particular, it is conceivable that the system is set up to generate 3D image data, in particular based on the principle of triangulation according to light section methods. The system can then preferably also comprise at least one projection device which projects at least one light pattern, for example parallel black/white line pairs or dots, at a known angle onto the object to be inspected. The projection device can include lighting, for example structured lighting or lasers.

The one or more detection units are arranged at a known angle to the projection device and/or lighting. In particular, the one or more detection unit picks up the light pattern deformed by the surface shape of the object to be inspected, for example a stripe pattern or dot pattern. The system thus enables the surface, e.g. curvatures or curves of the object to be inspected, to be made visible. Possible dents or dings can also be made visible in this way.

With a sufficiently high image repetition rate, the projection can be carried out by flashing in the same section of the one or more detection units in which the optical inspection is carried out and the full field of view can be utilized in each case. Alternatively, the projection can also be limited to only part of the image section so that optical defect inspection and 3D measurement can be carried out simultaneously, i.e. during the same image acquisition.

It should be understood that in order to increase production speeds (for example at a cable and/or object speed), one or more or each of the detection units may be usable, which may be configured for a higher frame rate and/or which may be operable with an enlarged image section. Additionally or alternatively, it may be conceivable that the number of detection units is increased, in particular duplicated, and the respective detection units are synchronized, for example in pairs. For example, a higher measuring speed can be achieved by arranging the duplicated detection units one behind the other.

Furthermore, the present invention provides a method according to the invention for the optical inspection of objects.

It should be understood that the method according to the invention can be carried out by means of the system described herein.

It should further be understood that any structural and/or functional features and/or properties and/or advantages described and/or to be described in connection with the system for optical inspection of objects according to the invention may also be part of and/or attributable to said method.

The method according to the invention for the optical inspection of objects comprises: providing an object to be inspected in a measurement area; optically detecting the object to be inspected by means of one or more detection units, in particular in a continuous manner; providing image information of the detected object by means of the one or more detection units; inspecting the detected object using the provided image information based on one or more, in particular positive, reference objects by means of a computing unit; and providing a corresponding inspection result about the object by means of the computing unit.

The method may further comprise: Projecting light, in particular light patterns, for example parallel black and white line pairs or dots, at a known angle onto the object to be inspected by a projection device. The projection device may comprise lighting, for example structured lighting or lasers. The method may further comprise: Detecting the surface shape of the object to be inspected by deformed light patterns, for example deformed stripe patterns or dot patterns.

It may be provided that the method comprises: determining an outer contour of the detected object in the image information by means of a locator module of the computing unit; and, optionally, deleting an information content assignable to an area outside the outer contour of the detected object in the image information by means of the locator module.

It may be provided that the inspecting comprises: analyzing the detected object for conformity with and/or deviations from one or more, in particular positive, reference objects using the image information by means of one or more detection modules of the computing unit; and providing a corresponding measured value by means of the one or more detection modules.

It may be provided that at least one recognition module is designed and programmed for symbol recognition analysis, in particular text recognition analysis, and/or at least one recognition module is designed and programmed for geometric measurement analysis, and/or at least one recognition module is designed and programmed for color analysis, and/or at least one recognition module is designed and programmed for surface analysis.

It may be provided that the inspection comprises: determining by means of an evaluator module of the computing unit whether the analyzed measured value is within predetermined limit values, whereby the corresponding inspection result about the object can be generated or is generated on the basis of this determination.

It may be provided that the method comprises: generating a first and/or at least one further, in particular positive reference object, in particular for subsequent inspections based on the image information of the detected object by means of a trainer module of the computing unit, if the detected object substantially corresponds to a target state.

It may be provided that the method comprises: training the one or more recognition modules on the basis of at least one, in particular positive, reference object by means of one or more teach-in modules of the computing unit.

Further preferred features and/or advantages of the present invention are the subject of the following description and the graphic representation of exemplary embodiments.

### BRIEF DESCRIPTION OF THE FIGURES

The figures show schematically:

FIG. 1 a system for the optical inspection of objects according to a first embodiment example;

FIG. 2 a system for the optical inspection of objects according to a second embodiment example;

FIG. 3 a detailed view of part of the system in FIG. 2;

FIG. 4 a functional view of part of the system in FIG. 2;

FIG. 5 a flowchart of the operation of the system of FIG. 1 and the system of FIG. 2 and a method for optical inspection of objects according to a third embodiment; and

FIG. 6 a side view of the detailed view in FIG. 3.

### DETAILED DESCRIPTION

Identical or functionally equivalent elements are marked with the same reference signs in all figures.

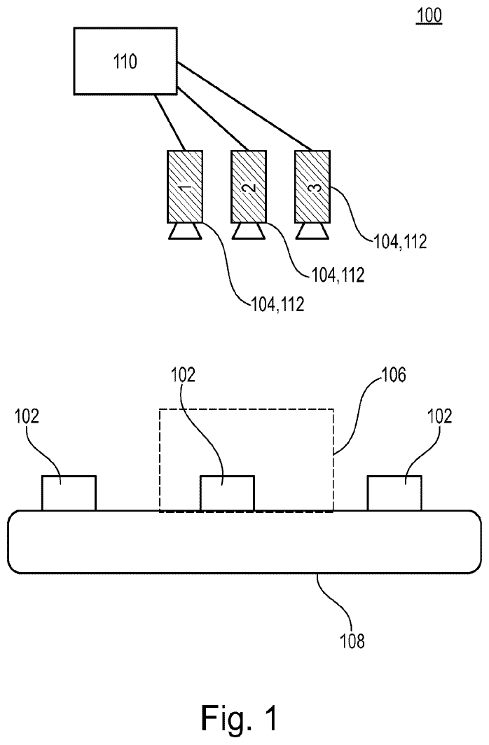

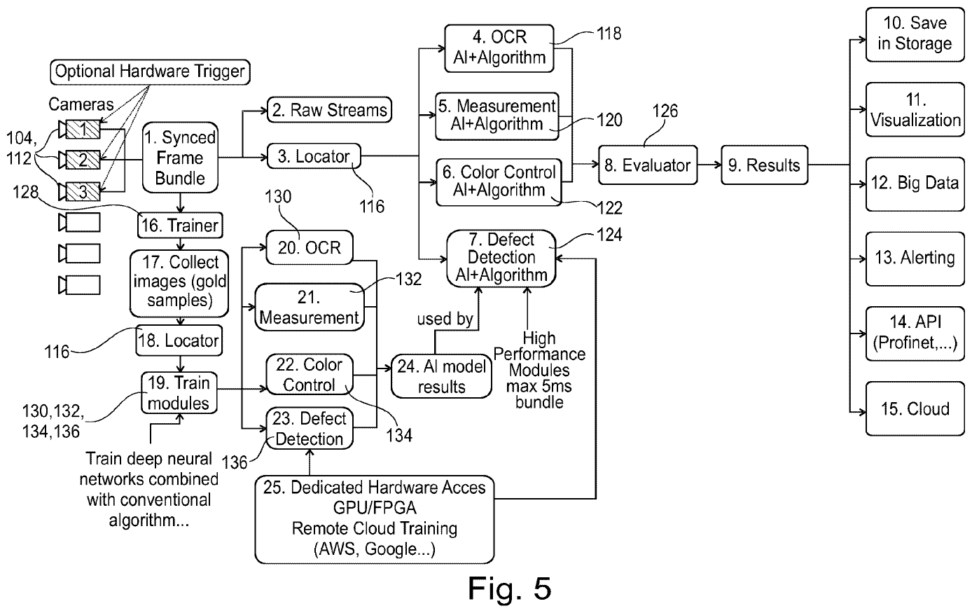

With reference to FIG. 1 in conjunction with FIG. 5, a system 100 according to the invention for the optical inspection of objects 102 according to a first embodiment example is shown schematically.

The system 100 for the optical inspection of objects 102 has several detection units 104, in the present case three detection units 104. It may be provided that the number of detection units 104 used is dependent on a size or dimensions of an object to be inspected. For example, four or more detection units 104 may also be included for larger diameters and/or comparable dimensional parameters.

By means of each detection unit 104, at least one object 102 to be inspected can be optically detected, in particular continuously optically detected, in a measuring range 106.

After optical detection, corresponding image information of the detected object 102 can be made available by means of each detection unit 104, in particular for further utilization or processing.

In other words, each detection unit 104 is configured for, in particular, continuous optical detection of at least one object 102 to be inspected in a measurement area 106 and for providing image information of the detected object 102.

Optical individual detection, in other words discontinuous detection, may be conceivable additionally or alternatively.

In the present embodiment example, the objects to be inspected are cylindrical objects, e.g. tree trunks, or plate-shaped objects, e.g. cookies. Any other type of object is also conceivable.

The measuring area 106 is arranged at and/or on a conveyor device, in this case a conveyor belt 108.

The detection units 104 are suitably arranged and aligned with respect to the measuring range 106, e.g. as in the present case above the conveyor belt 108, in order to be able to optically detect the objects 102 in the measuring range 106. Any suitable arrangement of the detection units 104 may be conceivable here.

Each detection unit 104 comprises a camera 112 for optically detecting the object 102 and a light source 114 for illuminating the object 102 (not shown in FIG. 1).

Each camera 112 is equipped with an objective 156.

The objective 156 may be a telecentric and/or optically corrected, e.g. classically rectified, lens.

Each light source 114 has at least one circuit board and a plurality of LEDs arranged in a regular two-dimensional pattern on the circuit board.

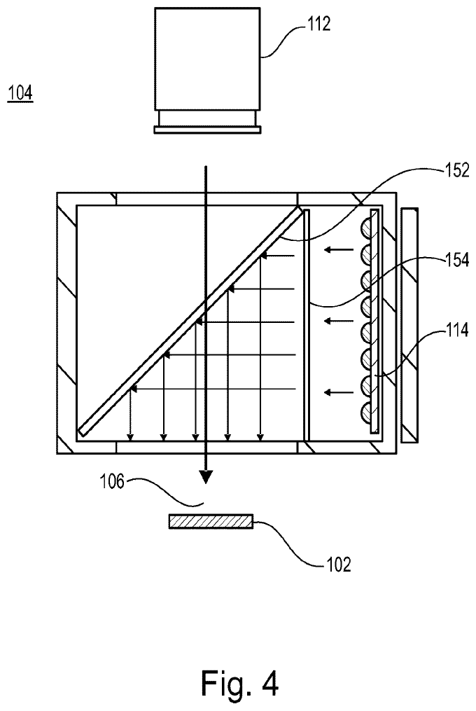

In the present embodiment example, the LEDs are arranged at least partially ring-lit around the camera lens opening to provide a ring light (not shown in FIG. 1). Additionally or alternatively, it is conceivable that the LEDs are arranged at least partially or completely relative to the camera lens opening to provide a coaxial light (see here, for example, FIG. 4).

Each light source 114 has a power range of substantially 20 to 70 watts, preferably from substantially 24 to 48 watts.

Alternatively, it is conceivable that each light source 114 has a power range of essentially 100-150 watts.

Each light source 114 has a color rendering index range of substantially 92 to 98, preferably substantially 94 to 96, in particular substantially 95 or 96.

Not shown in FIG. 1 is that the system 100 may further comprise at least one projection device which projects at least one light pattern, for example parallel black/white line pairs or dots, at a known angle onto the object to be inspected. The projection device may comprise illumination, for example structured illumination or laser. At least one detection unit 104 can be arranged at a known angle to the projection device and/or lighting The system 100 thus enables the surface, for example curvatures or curves of the object to be inspected, to be made visible and/or analyzed.

Furthermore, the system 100 has a computing unit 110, which is operatively connected to the detection units 104, in particular is electrically and/or signal-technically connected.

The computing unit 110 is designed and programmed to inspect the captured object 102 using the image information provided.

This inspection is based on one or more positive reference objects.

A positive reference object is a good example and/or a good sample of the objects 102 to be inspected, in particular from which the inspection is based as an ideal state.

A corresponding inspection result for the object 102 in question can be provided by the computing unit 110, in particular for further use.

In other words, the computing unit 110 is designed and programmed to provide a corresponding inspection result about the object 102 in question, in particular for further use.

With reference to FIG. 5 in conjunction with FIG. 1, the computing unit 110 is now described in particular:

The computing unit 110 is designed and programmed to receive image information from the detection units 104 as a data bundle provided with a time stamp and/or to summarize the image information from the detection units 104 as a data bundle and to provide it with a time stamp (cf. field 1 of FIG. 5). This serves in particular to reliably assign the image information.

As shown in FIG. 5, the optical detection by the detection units 104 can optionally be synchronized or synchronized by means of hardware triggers. In this case, an analog signal is simultaneously sent to a trigger input of the detection units 104 and the optical detection is synchronized in the range of nanoseconds, but this is not absolutely necessary in the present embodiment example.

In other words, it may be provided that each detection unit 104 comprises a trigger input by means of which an analog trigger signal is receivable, wherein each detection unit 104 is configured to start and/or synchronize an optical detection in particular with the computing unit 110 as soon as the analog trigger signal is received.

The computing unit 110 has a locator module 116 (see field 3 of FIG. 5).

Locator module 116 is configured as an artificial neural network that has already been pre-trained or trained.

The image information, in particular the bundled image information (see field 1 of FIG. 5), can be received by means of the locator module 116.

Additionally or alternatively, the image information can be provided on a separate stream so that it can be retrieved and/or received by other processes and/or modules if required (see field 2 of FIG. 5).

The locator module 116 can be used to determine an outer contour of the captured object 102 in the image information.

Information content that can be assigned to an area outside the outer contour of the detected object 102 can be deleted from the image information by means of the locator module 116.

In other words, the locator module 116 is configured and programmed to determine an outer contour of the captured object 102 in the image information and to delete an information content in the image information which is assignable to an area outside the outer contour of the captured object 102.

Furthermore, the computing unit 110 has several, here four, detection modules 118, 120, 122, 124 (see fields 4 to 7 of FIG. 5).

The recognition modules 118, 120, 122, 124 are each configured as a combination of artificial neural networks and conventional algorithms.

The image information from the locator module 116 can be received by means of the detection modules 118, 120, 122, 124.

By means of the detection modules 118, 120, 122, 124, the detected object 102 can be analyzed for conformity with and/or deviations from one or more positive reference objects on the basis of the image information.

A corresponding measured value can be provided by means of the respective detection modules 118, 120, 122, 124.

In other words, each detection module 118, 120, 122, 124 is configured and programmed to use the image information to analyze the detected object 102 for correspondence with and/or deviations from one or more positive reference objects and to provide a corresponding measurement value.

The detection modules 118, 120, 122, 124 comprise a first detection module 118, a second detection module 120, a third detection module 122 and a fourth detection module 124.

The first recognition module 118 is designed and programmed for symbol recognition analysis, in particular text recognition analysis.

In particular, the first recognition module 118 is designed and programmed as an OCR module in order to be able to analyze in particular imprints (e.g. markings, codes, lettering, and/or serial numbers) on the objects 102 in question. The first recognition module 118 is pre-trained or taught accordingly.

The second detection module 120 is designed and programmed for geometric measurement analysis.

By means of the second recognition module 120 for geometric measurement analysis, for example, a concrete dimension (e.g. a diameter) at defined points within the image information of the objects 102 in question can be calculated, in particular concretely quantitatively calculated.

The third detection module 122 is designed and programmed for color analysis.

In other words, the third detection module 122 is configured to monitor the color of the objects 102 in question.

For example, a color deviation of the objects 102 in question can be calculated using the third detection module 122, for example by specifying a percentage deviation as a measured value.

The fourth detection module 124 is designed and programmed for surface analysis.

For example, fractures, cracks, cuts, holes, dents, pimples, foreign particles and/or air bubbles in and/or on the objects can be determined by means of the fourth detection module 124 for surface analysis.

The computing unit 110 also has an evaluator module 126 (see field 8 of FIG. 5).

The measured values determined by the detection modules 118, 120, 122, 124 can be received by the evaluator module 126.

The evaluator module 126 can be used to determine whether the analyzed measured value is within predetermined limit values.

The inspection result for the object 102 can be generated on the basis of this determination.

In other words, the evaluator module 126 is configured and programmed to determine whether the analyzed measured value is within predetermined limits, wherein the corresponding inspection result about the object 102 can be generated based on this determination.

In other words, the evaluator module 126 can be used to classify the measured values and then provide a corresponding inspection result.

The limit values are stored in the computing unit 110 and/or can be accessed by the computing unit 110.

The limit values can be flexibly changed by a user, in particular as a function of an object 102 to be inspected and/or a quality expectation of an object 102 to be inspected. This can be done, for example, via an input device of the system 100 associated with the computing unit 110.

Once the inspection result has been generated, it can be made available or provided for further use (see field 9 of FIG. 5).

A process cycle, in particular a process cycle between field 1 to field 9 of FIG. 5, lasts between 3 and 7 ms, in particular essentially 5 ms.

One or the inspection result can be made available, in particular to an output unit of the system 100 for output to the user and/or to an interface for transmission to an additional system unit and/or unit assigned or assignable to the system.

A non-exhaustive list of examples can be taken from FIG. 5 (see fields 10 to 15 of FIG. 5). An output unit can be, for example, a display unit, e.g. a screen (cf. field 11 of FIG. 5) and/or an alarm unit, e.g. an acoustic and/or visual alarm unit (cf. field 13 of FIG. 5). The additional system unit and/or the unit assigned or assignable to the system 100 may, for example, be configured as a big data unit (cf. field 12 of FIG. 5) and/or as a cloud (cf. field 15 of FIG. 5). Additionally or alternatively, the inspection result may be storable in a memory unit of the system 100 (cf. field 10 of FIG. 5). Additionally or alternatively, the interface can be configured as a programming interface (e.g. API (e.g. Profinet)) (see field 14 of FIG. 5).

Furthermore, the computing unit 110 has a trainer module 128 (see field 16 of FIG. 5).

The image information, in particular the bundled image information (see field 1 of FIG. 5), can be received by means of the trainer module 128.

A first, in particular all first, or further (in particular second, third, etc.), positive reference object for subsequent inspections can be generated on the basis of this image information of the captured object 102 by means of the trainer module 128.

In particular, these reference objects can be generated by means of the trainer module 128 if the captured object 102 substantially corresponds to a target state.

In other words, the trainer module 128 is designed and programmed to generate a first and/or at least one further positive reference object based on the image information of the captured object 102, in particular for subsequent inspections, if the captured object 102 substantially corresponds to a target state.

In particular, the trainer module 128 is used to access the generated image information from the detection units 104 to generate image information or image material for positive reference objects when the detected object 102 substantially corresponds to a target state.

The target state can be defined and/or determined by a user in the computing unit 110 (e.g. via an input device of the system 100).

It may be provided that the target state has a tolerance range. In other words, the positive reference objects or their image information can comprise only or predominantly image information from positive reference objects, which consequently have no or only a few production errors/deviations within an acceptable tolerance range. If production errors/deviations are included, they must be clearly outnumbered, otherwise they are defined as acceptable production characteristics.

The positive reference objects can be stored in the computing unit 110 and/or can be stored and/or accessed for further use (see field 17 of FIG. 5).

The image information of the reference objects can be transferred to the locator module 116 and/or can be received by the locator module 116 (cf. field 18 of FIG. 5) in order to determine an outer contour of the captured object 102, in this case the positive reference object, in the image information and to delete information content in the image information which can be assigned to an area outside the outer contour of the captured object 102, in this case the positive reference object.

Furthermore, the computing unit 110 has several, here four, teach-in modules 130, 132, 134, 136 (see field 19 of FIG. 5; divided separately: see fields 20 to 23 in FIG. 5).

The training modules 130, 132, 134, 136 are each configured as a combination of artificial neural networks and conventional algorithms.

Each teach-in module 130, 132, 134, 136 is configured and programmed to have access to and/or use resources from: dedicated hardware, in particular GPU and/or FPGA, and/or a remote cloud and/or remote data centers. In particular, the dedicated hardware may be part of the system 100. This serves in particular to increase performance.

The teach-in modules 130, 132, 134, 136 correspond to the detection modules 118, 120, 122, 124.

In other words, the teach-in modules 130, 132, 134, 136 comprise a first teach-in module 130, a second teach-in module 132, a third teach-in module 134 and a fourth teach-in module 136.

By means of the teach-in modules 130, 132, 134, 136, the respective corresponding recognition modules 118, 120, 122, 124 can be trained on the basis of at least one positive reference object.

In other words, the teach-in modules 130, 132, 134, 136 are designed and programmed to train the recognition modules 118, 120, 122, 124 on the basis of at least one positive reference object.

Each detection module 118, 120, 122, 124 is assigned to a teach-in module 130, 132, 134, 136.

The first teach-in module 130 is associated with the first recognition module 118 and can train it. In other words, the first teach-in module 130 is designed and programmed for a symbol recognition analysis, in particular text recognition analysis, or for corresponding training.

The second teach-in module 132 is associated with the second recognition module 120 and can train it. In other words, the second teach-in module 132 is designed and programmed for a geometric measurement analysis or for corresponding training.

The third teach-in module 134 is associated with the third recognition module 122 and can train it. In other words, the third teach-in module 134 is designed and programmed for a color analysis or for corresponding training.

The fourth teach-in module 136 is associated with the fourth detection module 124 and can train it. In other words, the fourth teach-in module 136 is designed and programmed for a surface analysis or for corresponding training.

As the teach-in modules 130, 132, 134, 136 teach or train the recognition modules 118, 120, 122, 124 using the positive reference objects, the recognition modules 118, 120, 122, 124 are continuously improved and become more reliable in their analysis of image information from captured objects 102.

With reference to the system of FIG. 1 in conjunction with FIG. 5, this can be operated in particular as follows:

A reference object 102 or a good example or a good sample is fed to the measuring area 106 via the conveyor belt 108. It is also conceivable that a reference object 102 or a good example or a good sample can be fed to the measuring area 106 in a free-floating manner, for example by means of a feeding and removal device spaced from the measuring area 106.

At least one detection unit 104 optically detects the object 102 and generates image information.

The image information is bundled and provided with a time stamp using the processing unit 110 (see field 1 of FIG. 5).

The trainer module 128 generates a first, positive reference object for subsequent inspections based on this image information of the captured object 102, since the captured object 102 is a good example or a good pattern and thus essentially corresponds to a target state (cf. field 16 of FIG. 5).

The first, positive reference object is stored (see field 17 of FIG. 5) and further processed by the locator module 116 (see field 18 of FIG. 5).

The locator module 116 is used to determine an outer contour of the captured object 102 in the image information.

An information content that can be assigned to an area outside the outer contour of the captured object 102 is deleted in the image information by means of the locator module 116.

The resulting image information is transferred to the training modules 130, 132, 134, 136 (see fields 19 to 23 of FIG. 5), which convert the image information into an AI model (see field 24 of FIG. 5) for training the recognition modules 118, 120, 122, 124.

Depending on the reference object detected, the relevant detection modules 118, 120, 122, 124 are now trained by the respective associated teach-in modules 130, 132, 134, 136, so that subsequent inspections can be carried out on the basis of at least this first reference object. Any number of reference objects can be trained.

After training or teaching at least the first reference object, subsequent inspections can be carried out.

This means that at least one detection unit 104 optically detects the object 102 to be inspected, which is moved into the measuring area 106 via the conveyor belt 108, and generates image information.

The image information is bundled and provided with a time stamp using the processing unit 110 (see field 1 of FIG. 5).

This image information is further processed by the locator module 116 (see field 3 of FIG. 5).

The locator module 116 is used to determine an outer contour of the captured object 102 in the image information.

An information content that can be assigned to an area outside the outer contour of the captured object 102 is deleted in the image information by means of the locator module 116.

The resulting image information is transferred to the recognition modules 118, 120, 122, 124 (see fields 4 to 7 of FIG. 5), which are already trained with at least the first reference object.

The detection modules 118, 120, 122, 124 use the image information to analyze the detected object 102 for correspondence with and/or deviations from the positive reference object and provide a respective corresponding measured value.

The evaluator module 126 is then used to determine whether this analyzed measured value is within predetermined limit values (see field 8 of FIG. 5).

In the present example of cookies as objects 102, for example, damaged and/or discolored, e.g. burnt, cookies can be reliably identifiable. In this case, geometric and/or color measurement values would be outside the predetermined limits.

In the present example of tree trunks as objects 102, for example, deformed and/or only partially debarked tree trunks can be reliably identified. In this case, geometric and/or color measurement values would be outside the predetermined limits.

The inspection result for object 102 is generated on the basis of this determination.

Once the inspection result has been generated, it can be made available or provided for further use (see field 9 of FIG. 5).

The inspection result is then provided in particular to an output unit of the system 100 for output to the user and/or to an interface for transmission to an additional system unit and/or unit assigned or assignable to the system (cf. fields 10 to 15 of FIG. 5), in order to be able to perform corresponding quality assurance actions (e.g. sorting out and/or further processing and/or warning and/or marking, etc.).

The system 100 is thus based in particular on the idea that the computing unit 110 inspects or can inspect objects 102 in particular purely on the basis of positive reference objects, for example good examples or good samples. In particular, at least one part, i.e. the recognition modules 118, 120, 122, 124, of the computing unit 110 can be taught or trained purely on the basis of said positive reference objects or good examples. In other words, this means that negative reference objects or bad examples are not required for an inspection. The system 100 can therefore be operated more efficiently. In particular, the efficiency of the system 100 is increased, as an inspection can only be carried out on the basis of said positive reference objects and, for example, a comparison with numerous negative reference objects is thus avoided. Furthermore, commissioning of the system 100 can be carried out quickly, since in particular an inspection of objects 102 can already be carried out with a positive reference object. In other words, the system 100 can initially be taught with a positive reference object, particularly with regard to object features to be inspected. Commissioning therefore requires (virtually) no specialist knowledge of the object 102 to be inspected, as the object features can be taught or trained using the positive reference object in accordance with a or the “teach & go” principle described. Furthermore, by the teach-in modules 130, 132, 134, 136 teaching or training the detection modules 118, 120, 122, 122 using positive reference objects, the reliability and efficiency of the analyses of the detection modules 118, 120, 122, 122 can be continuously increased in dependence on a quantity of positive reference objects by means of which the detection modules 118, 120, 122, 122 can be trained.

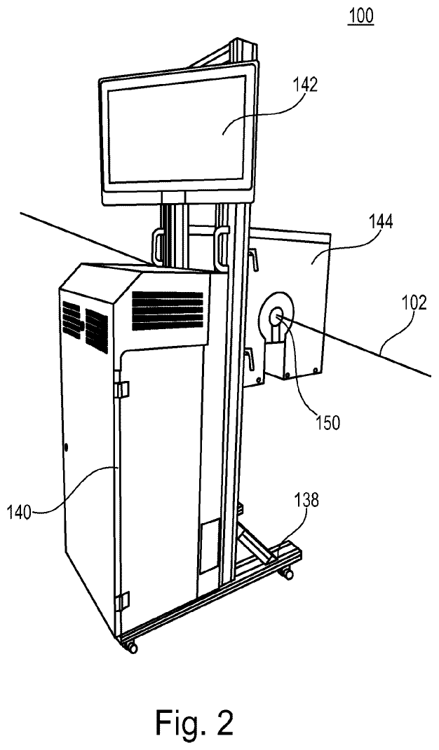

With reference to FIGS. 2 to 4 in conjunction with FIG. 5, a system 100 according to the invention for the optical inspection of objects 102 according to a second embodiment example is shown schematically.

The system according to the second embodiment example essentially corresponds to the system according to the first embodiment example, so that only the differences are described below.

In the present embodiment example, the objects to be inspected are 102 elongated or endless objects, here as an example: a cable. Any other type of object is also conceivable.

In other words, the system 100 can be considered a cable inspection system, in particular a cable inspection device.

With reference to FIG. 2, the system 100 has a carrying device 138, which is designed as a profile frame, a housing 140, a combined display unit and input device in the form of a touch screen 142, and an enclosure 144 for a measuring chamber 146.

The housing 140, the touch screen 142 and the enclosure 144 are arranged on the carrying device 138.

The enclosure 144 is adjustable in height on the carrying device 138 by means of a corresponding connection, which is well known in the prior art.

The system 100, in particular the carrying device 138, is configured to be mobile, which can be achieved in the present embodiment example by means of brakable and/or lockable rollers.

The computing unit 110, for example in the form of a computer device, is arranged in the housing 140.

Furthermore, the following are arranged in the housing 140 in particular: a GPU device, which is operatively connected to the computing unit 110 and/or forms part of it and/or is associated with it, a cooling device and/or a fan, a power supply (e.g. power supply units, fuse, cabling), one or more communication modules (e.g. Profibus, Profinet, 4G/5G router, etc.), one or more operating elements (e.g. main switch on/off, height adjustment UP/DOWN).

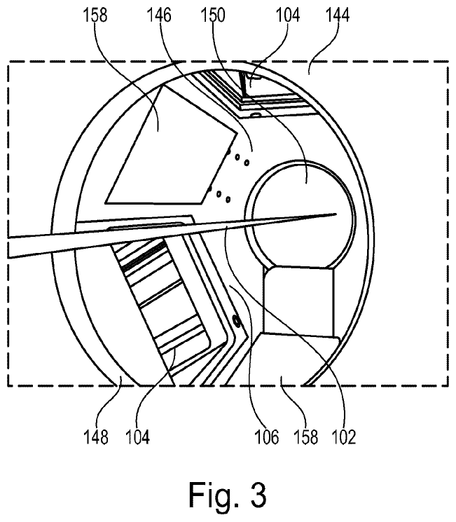

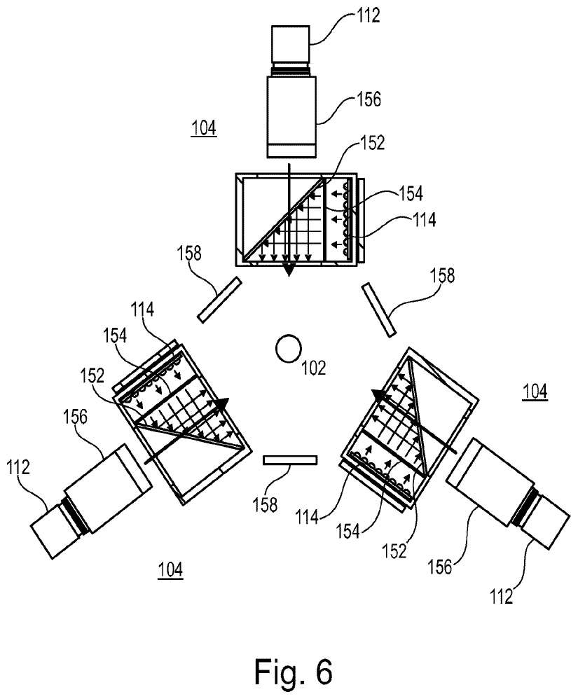

The enclosure 144 surrounds a or the measuring chamber 146, in which the measuring area 106 is arranged, as can be seen in FIG. 3 and/or FIG. 6.

The enclosure 144 may further include a compressed air device for air measurement and/or dust protection (not shown in the figures).

One wall of the measuring chamber 146 is provided with a light-absorbing or light-absorbing coating.

The measuring chamber 146 has an inlet opening 148 for receiving the object 102 to be inspected into the measuring chamber 146 and an outlet opening 150 for discharging the inspected object 102 out of the measuring chamber 146.

In the present case, the said measuring range 106 is arranged between the input opening 148 and the output opening 150 in the measuring chamber 146.

An object 102 to be inspected, in this case the cable, can be passed through the input opening 148 and the output opening 150 and can thus extend through the measuring chamber 146 in order to be optically detectable there.

The multiple, here three, detection units 104 are arranged in the enclosure 144 for continuous optical detection of the object 102 in the measuring chamber 146, in particular in the measuring area 106.

The detection units 104 are arranged at regular intervals from one another and, in particular, radially around the measuring range 106.

As can be seen in FIGS. 3 and 6, the detection units 104 are arranged at 120° intervals from one another around the measuring range 106, in particular around a longitudinal axis of the measuring range 106. In FIGS. 3 and 6, the longitudinal axis may substantially coincide with the object 102, i.e. the cable.

Additionally or alternatively, it may be provided that several detection units 104 are arranged at regular distances from each other and in particular longitudinally along the measuring range 106. For example, the system 100 may comprise six detection units 104, wherein in each case three detection units 104 forming a group are arranged radially around the measuring range, as already shown in FIGS. 3 and 6, and the respective groups are arranged longitudinally along the measuring range 106. To a certain extent, a 2×3 radial arrangement can be seen here, i.e., in the case of FIGS. 3 and 6, a further three detection units 104 would still be arranged behind and/or in front of the already apparent detection units 104.

Each detection unit 104 is configured to coaxially illuminate the object 102 during continuous optical detection of the object 102 in the measurement chamber 106.

Furthermore, as can be seen in FIGS. 3 and 6, each detection unit 104 is assigned a surface element 158, in particular a surface element designed as a projection surface.

In particular, the respective associated detection units 104 and surface elements 158 are arranged on opposite sides of the object 102 with respect to the object 102.

In particular, the detection unit 104 and the surface element 158 are aligned with respect to each other so that an axis of view of the detection unit 104 is directed substantially perpendicular to the surface element 158.

The surface element 158 serves as a background for the object 102, for example in order to be able to capture the object 102, in particular its contours, more clearly. This can improve accuracy.

The surface element 158 comprises a light-absorbing, to a certain extent light-absorbing, material and/or is at least partially formed from such a material. For example, the surface element 158 may be coated with a light-absorbing, so to speak light-absorbing, material.

As shown in FIG. 4, each detection unit 104 includes a camera 112 for optically detecting the object 102, a light source 114 for illuminating the object 102, and a beam splitter 152 for redirecting emitted light from the light source 114.

Each detection unit 104 further comprises a diffuser 154 disposed between the light source 114 and the beam splitter 152.

The diffuser 154 is used to provide a highly diffuse bright field, which can ensure even more uniform illumination and prevent reflections even better.

The camera 112, the light source 114 and the beam splitter 152 are arranged relative to one another in such a way that a central optical axis of the camera 112 (cf. arrow from camera 112 to object 102 in FIG. 4) and light beams that can be emitted by the light source (cf. remaining arrows in FIG. 4) run parallel and/or coaxially to one another.

In particular, the camera 112 and the light source 114 are arranged substantially perpendicular to each other and the beam splitter 152 is arranged at an angle of substantially 45° to the central optical axis of the camera 112 and a light emitting direction of the light source 114.

Due to the construction with the beam splitter 152, in particular semi-transparent mirror, it is possible to achieve that the camera 112 looks directly through the mirror glass of the beam splitter 152, which is transparent from one side, onto the object 102 and not—as with direct illumination (e.g. with a ring light)—“through” the light source 114. This can prevent the camera 112 from being “blinded” and image information about the captured object 102 from being read out due to overexposure. As a result, the system 100 can be operated more reliably and efficiently.

Each light source 114 comprises at least one circuit board and a plurality of LEDs, which are arranged in a regular two-dimensional pattern on the circuit board (see FIG. 4).

Each light source 114 has a power range of substantially 20 to 60 watts, preferably from substantially 24 to 48 watts.

Alternatively, it is conceivable that each light source 114 has a power range of essentially 100-150 watts.

This can provide powerful illumination for detecting even the smallest errors, which can also enable very fast image captures or very short exposure times by the camera 112.

Furthermore, due to the short adjustable exposure times of the cameras 112, the enclosure 144 or the measuring chamber 146 cannot be completely closed. In other words, the input opening 148 and the output opening 150 of the measuring chamber 146 do not have to be completely light-tight. Due to the high luminosity of the installed light source 114, any residual ambient light entering can be compensated for.

Furthermore, each light source 114 has a color rendering index range of substantially 92 to 98, preferably substantially 94 to 96, in particular substantially 95, which may enable reliable color analysis.

With regard to the computing unit 110, which is arranged in the housing 140, reference is made to the explanations of the first embodiment example.

With reference to the system 100 of FIG. 2 in conjunction with FIG. 5, this is in particular essentially operable like the system 100 of FIG. 1 in conjunction with FIG. 5, which has already been described.

In the case of the system shown in FIG. 2, the object 102, in this case the cable, is continuously guided and conveyed through the measuring chamber 106.

This means that the detection units 104 continuously detect the object 102.

In other words, the object 102, in this case the cable, can be inspected or inspectable in-line.

A conveyor device (not shown in the figures) is assigned to the system 100 for conveying through the measuring area 106.

The conveyor device is designed, for example, as an unwinding device and a rewinding device and is arranged respectively upstream and downstream of the system 100.

In other words, the cable can be conveyed by means of unwinding and rewinding through the measuring area 106 and optionally through a production facility in which the system 100 is arranged or can be arranged.

The detection modules 118, 120, 122, 124 are taught using a good example or good sample of a cable.

The inspection of cables in particular can include, for example:
Analysis of the product surface and/or detection and classification of color deviations (monochrome/multicolor), inclusions, cracks, scratches, streaks, abrasion, stripes, streaks, lack of material, excess material, geometric deviations (e.g. dents, bubbles, kinks, constrictions, dents, holes), open core (e.g. visible wire strands); and/or
Measurement of the product geometry: diameter, linearity (e.g. product curvature); and/or
Imprint inspection: Analysis of the quality and content accuracy of imprints (e.g. inkjet, laser, embossing, etc.), logos, serial numbers, barcodes and/or QR codes, matrix text, product designations and parameters, length specifications (e.g. meter specifications for underground cables).

It should be understood that the above list is exemplary and not exhaustive.

Furthermore, it should be understood that all advantages of the system 100 according to the first embodiment example are also advantages of the system 100 according to the second embodiment example or are assignable thereto.

Further advantages of the system 100 according to the second embodiment example are in particular:
The training (deep neural networks for analyzing) of new products takes place purely on the basis of good examples. No bad examples (NiO) are required. Occasional errors may occur on the sample material as long as they are only minor.
The cable (e.g. extrusion product) may vibrate as long as it does not leave the image section of the camera. The vibrations can be compensated for using the locator module 116.
The surface of the extruded product is completely (essentially 100%) recorded and analyzed.
The detection area is shielded from ambient light by the enclosure 144 and therefore works independently of the ambient light situation.
Due to the short adjustable exposure time of the camera 112, the housing 144 does not have to be completely closed. The entry and exit areas, in particular the input and output openings 148, 150, for the object 102, in this case cables, do not have to be completely light-tight.
The high luminosity of the built-in light source 114 compensates for any residual ambient light.
Water droplets from the cooling process are recognized as such and not as product defects due to the detection modules used and in particular the illumination.

With reference to FIG. 5, a method according to the invention for the optical inspection of objects 102 will be described below, which can be carried out in particular by systems 100 already described according to the first and second embodiments.

It should be understood that any structural and/or functional features and/or characteristics and/or advantages described in connection with the system 100 for optically inspecting objects 102 according to the invention may also be part of and/or attributable to said method.

The method comprises providing an object 102 to be inspected in a measuring area 106.

The method further comprises optically detecting the object 102 to be inspected by means of one or more, here three, detection units 104, in particular in a continuous manner.

The optical detection comprises an optical detection of the object 102 by means of a camera 112 and an especially coaxial illumination of the object 102 to be inspected by means of a light source 114, wherein especially the optical detection by means of the camera 112 and the especially coaxial illumination by means of the light source 114 take place simultaneously.

The method further comprises providing image information of the detected object 102 by means of the detection units 104 (see field 1 of FIG. 5).

It is not explicitly shown that the method may further comprise: Projecting light, in particular light patterns, for example parallel black and white line pairs or dots, at a known angle onto the object to be inspected by a projection device. The projection device may comprise illumination, for example structured illumination or laser; detecting the surface shape of the object to be inspected by deformed light patterns, for example deformed stripe patterns or dot patterns.

The method further comprises inspecting the captured object 102 using the provided image information based on one or more, in particular positive, reference objects by means of a computing unit 110 (see fields 1 to 8 of FIG. 5).

The method further comprises providing a corresponding inspection result about the object 102 by means of the computing unit 110 (cf. field 9 of FIG. 5).

The method further comprises: determining an outer contour of the captured object 102 in the image information by means of a locator module 116 of the computing unit 110 and deleting an information content, which can be assigned to an area outside the outer contour of the captured object 102, in the image information by means of the locator module 116 (cf. field 3 of FIG. 5).

The inspecting comprises: analyzing the captured object 102 for conformity with and/or deviations from one or more, in particular positive, reference objects using the image information by means of one or more detection modules 118, 120, 122, 124 of the computing unit 110; and providing a corresponding measured value by means of the one or more detection modules 118, 120, 122, 124 (cf. fields 4 to 7 of FIG. 5).

The inspection further comprises: Determining by means of an evaluator module 126 of the computing unit 110 whether the analyzed measured value is within predetermined limit values (cf. field 8 of FIG. 5), wherein the corresponding inspection result about the object 102 can be generated or is generated on the basis of this determination (cf. field 9 of FIG. 5).

The method further comprises: Generation of a first and/or at least one further, in particular positive reference object, in particular for subsequent inspections, on the basis of the image information of the captured object 102 by means of a trainer module 128 of the computing unit 110 if the captured object 102 substantially corresponds to a target state (cf. fields 1 and 16 with 17 of FIG. 5).

The method further comprises: determining an outer contour of the captured reference object 102 in the image information by means of the locator module 116 of the computing unit 110 and deleting an information content, which can be assigned to an area outside the outer contour of the captured reference object 102, in the image information by means of the locator module 116 (cf. field 18 of FIG. 5).

The method further comprises: Training the one or more recognition modules 118, 120, 122, 124 on the basis of at least one, in particular positive, reference object by means of teach-in modules 130, 132, 134, 136 of the computing unit 110 (see fields 19 to 24 of FIG. 5).

The method may comprise, for example, that the object 102 to be inspected is continuously movable or moved through the measuring area 106, for example of a measuring chamber 146.

### List of Reference Symbols

100 System
102 Object
104 Detection unit
106 Measuring range
108 Conveyor belt
110 Computing unit
112 Camera
114 Light source
116 Locator module
118 First recognition module
120 Second detection module
122 Third detection module
124 Fourth recognition module
126 Evaluator module
128 Trainer module
130 First teach-in module
132 Second teach-in module
134 Third teach-in module
136 Fourth teach-in module
138 Carrying device
140 Housing
142 Touch screen
144 Enclosure
146 Measuring chamber
148 Input opening
150 Outlet opening
152 Beam splitter
154 Diffuser
156 Objective
158 Surface element

1. A system for optical inspection of objects, comprising:
one or more detection units for, continuously optically detecting at least one object to be inspected in a measuring range and for providing image information of the detected object; and
a computing unit which is designed and programmed to inspect the detected object using the image information provided based on one or more reference objects and to provide a corresponding inspection result for the object in question.

2. The system according to claim 1, wherein
the computing unit has a locator module which is designed and programmed to determine an outer contour of the detected object in the image information.

3. The system according to claim 1, wherein
the computing unit has one or more detection modules, which are designed and programmed to use the image information to analyze the detected object for conformity with and/or deviations from the one or more reference objects and to provide a corresponding measured value.

4. The system according to claim 3, wherein:
the one or more detection modules is designed and programmed for symbol recognition analysis, and/or
the one or more detection modules is designed and programmed for geometric measurement analysis, and/or
the one or more detection modules is designed and programmed for color analysis, and/or
the one or more detection modules is designed and programmed for surface analysis.

5. The system according to claim 3, wherein
the computing unit has an evaluator module which is designed and programmed to determine whether the analyzed measured value is within predetermined limit values and generate the corresponding inspection result for the object based on whether the analyzed measured value is within the predetermined limit values.

6. The system according to claim 1, wherein
the computing unit has a trainer module which is designed and programmed to generate a first and/or at least one further reference object on the basis of the image information of the detected object if the detected object substantially corresponds to a target condition.

7. The system according to claim 3, wherein
the computing unit has, corresponding to the one or more detection modules, one or more teach-in modules, which are designed and programmed in order to train the one or more detection modules, on the basis of the one of more reference objects.

8. The system according to claim 1, wherein
each detection unit comprises a trigger input by means of which an analog trigger signal is receivable, wherein each detection unit is configured to start and/or synchronize an optical detection, with the computing unit, as soon as the analog trigger signal is received.

9. A method of optically inspecting objects, the method comprising:
providing an object to be inspected in a measuring area;
optically detecting the object to be inspected by means of one or more detection units;
providing image information of the detected object by means of the one or more detection units;
inspecting the detected object using the provided image information based on one or more reference objects by means of a computing unit; and
providing a corresponding inspection result about the object by means of the computing unit.

10. The method according to claim 9, the method further comprising:
determining an outer contour of the detected object in the image information by means of a locator module of the computing unit;
wherein inspecting the detected object comprises:
analyzing the detected object for correspondence with and/or deviations from one or more reference objects using the image information by means of one or more detection modules of the computing unit; and
providing a corresponding measured value by means of the one or more detection modules, and/or
wherein the one or more detection modules is designed and programmed for symbol recognition analysis, geometric measurement analysis, color analysis, and/or surface analysis.

11.-15. (canceled).

16. A system for optically inspecting linear objects, comprising:
a conveyor device for continuously guiding a linear object to be inspected through a measuring area;
one or more detection units for optically detecting the linear object in the measuring area and for providing image information of the linear object; and
a computing unit which is designed and programmed to inspect the linear object on the basis of the image information provided and to provide a corresponding inspection result about the linear object,
the computing unit having at least one recognition module which is designed and programmed to analyze the image information for conformity with and/or deviations from a predetermined good-sample for the linear object to be inspected.

17. The system according to claim 16, wherein:
the at least one recognition module comprises an artificial neural network for teaching a good-sample, and/or
the computing unit is designed and programmed to generate the good-sample from the captured image information of a section of the linear object, and/or
a plurality of stationary detection units are arranged distributed around the linear object in a circumferential direction, and/or
the linear object is guided through a measuring range in a free-floating manner from roll to roll, and/or
the measuring area is at least partially shielded from ambient light by an enclosure, and/or
the image information can be provided as a high-speed image sequence with more than 500 images per second by means of a camera of each of the plurality of stationary detection units, and/or
the inspection result comprises at least one property of the linear object from the group comprising circumferential geometry, imprints, color, defects, foreign particles, and/or
the inspection result can be provided on an output unit in-line in the passage of the linear object, and/or
the computing unit is designed and programmed to determine the position of a detected defective property along the linear object.

18. The method according to claim 10,
wherein inspecting the detected object comprises:
determining, by means of an evaluator module of the computing unit, whether the analyzed measured value is within predetermined limit values, and generating the corresponding inspection result about the object based on whether the analyzed measured value is within the predetermined limit values, and/or
wherein the method further comprises:
generating a first and/or at least one further reference object on the basis of the image information of the detected object by means of a trainer module of the computing unit, if the detected object substantially corresponds to a target condition.

19. The method according to claim 18, the method further comprising:
training the one or more detection modules on the basis of the one or more reference objects by means of one or more teach-in modules of the computing unit.

20. The system according to claim 1, wherein the one or more reference objects are positive reference objects.

21. The system according to claim 2, wherein the locator module is designed and programmed to delete an information content corresponding to an area outside the outer contour of the detected object in the image information.

22. The system according to claim 4, wherein the symbol recognition analysis is text recognition analysis.

23. The method according to claim 9, wherein optically detecting the object comprises optically detecting the object in a continuous manner.

24. The method according to claim 10, wherein the symbol recognition analysis is text recognition analysis.

25. The method according to claim 10, the method further comprising deleting an information content corresponding to an area outside the outer contour of the detected object in the image information by means of the locator module.
